(19) United States
(12) Patent Application Publication
(10) Pub. No.: US 2017/0164004 A1
(43) Pub. Date: Jun. 8, 2017

(54) METHOD AND DEVICE FOR PROCESSING MULTI-VIEW VIDEO SIGNAL

(71) Applicant: KT CORPORATION, Gyeonggi-do (KR)

(72) Inventors: Bae Keun LEE, Seoul (KR); Joo Young KIM, Seoul (KR)

(73) Assignee: KT CORPORATION, Gyeonggi-do (KR)

(21) Appl. No.: 15/322,179

(22) PCT Filed: Jul. 2, 2015
(86) PCT No.: PCT/KR2015/006798

§ 371 Date: Dec. 27, 2016

(30) Foreign Application Priority Data
Jul. 4, 2014 (KR) 10-2014-0083992

(51) Int. Cl. H04N 19/597; H04N 19/63; H04N 19/176; H04N 19/62; H04N 13/00; H04N 19/119

(52) U.S. Cl. CPC H04N 19/597; H04N 13/0022; H04N 19/119; H04N 19/176; H04N 19/62; H04N 19/63; H04N 2013/0081

(57) ABSTRACT

A multiview video signal processing method according to the present invention determines an intra prediction mode of a current depth block, determines a partition pattern of the current depth block according to the determined intra prediction mode, induces a predicted depth value of the current depth block on the basis of the determined partition pattern, and restores the current depth block by using the predicted depth value and an offset value (DcOffset) for the current depth block.

### TECHNICAL FIELD

The present invention relates to a method and apparatus for encoding a video signal.

### BACKGROUND ART

Demands for high-resolution, high-quality video such as High Definition (HD) video and Ultra High Definition (UHD) video have recently been increasing in a variety of application fields. As video data has a higher resolution and a higher quality, the amount of the video data increases relative to traditional video data. Therefore, if video data is transmitted on a conventional medium such as a wired/wireless wideband circuit or stored on a conventional storage medium, transmission cost and storage cost increase. To solve the problems encountered with higher-resolution, higher-quality of video data, high-efficiency video compression techniques may be used.

There are a variety of video compression techniques including inter-prediction in which pixel values included in a current picture are predicted from a picture previous to the current picture or a picture following the current picture, intra-prediction in which pixel values included in a current picture are predicted using pixel information within the current picture, and entropy encoding in which a short code is assigned to a more frequent value and a long code is assigned to a less frequent value. Video data can be effectively compressed and transmitted or stored, using these video compression techniques.

Meanwhile, along with the increasing demands for high-resolution video, demands for Three-Dimensional (3D) video content as a new video service have also been increasing. Video compression techniques for effectively providing HD and UHD 3D video content are under discussion.

### DISCLOSURE

### Technical Problem

An object of the present invention is to provide a method and apparatus for performing inter-view prediction using a disparity vector in encoding/decoding a multiview video signal.

Another object of the present invention is to provide a method and apparatus for deriving a disparity vector of a texture block using depth data of a depth block in encoding/decoding a multiview video signal.

Another object of the present invention is to provide a method and apparatus for deriving a disparity vector from a neighbor block of a current texture block in encoding/decoding a multiview video signal.

Another object of the present invention is to provide a method and apparatus for encoding a depth image using a depth modeling mode in encoding/decoding a multiview video signal.

Another object of the present invention is to provide a method and apparatus for reconstructing a depth block by selectively using a depth look-up table in encoding/decoding a multiview video signal.

Another object of the present invention is to provide a method and apparatus for signaling a segment DC flag in encoding/decoding a multiview video signal.

Another object of the present invention is to provide a method and apparatus for acquiring an absolute offset value by entropy decoding based on context-based binary arithmetic coding in encoding/decoding a multiview video signal.

### Technical Solution

In a method and apparatus for decoding a multiview video signal according to the present invention, an intra-prediction mode of a current depth block is determined, a partition pattern of the current depth block is determined according to the determined intra-prediction mode, and a prediction depth value of the current depth block is derived based on the determined partition pattern.

In the method and apparatus for decoding a multiview video signal according to the present invention, determining the intra-prediction mode comprises determining, based on at least one of a depth mode DC flag or a intra-view prediction flag, whether the current depth block uses a depth modeling mode, obtaining, based on a depth mode DC flag or a intra-view prediction flag, adaptively DMM identification information relating to the current depth block from the bit stream when the current depth block uses the depth modeling mode, and determining the intra-prediction mode of the current depth block based on the obtained DMM identification information.

In the method and apparatus for decoding a multiview video signal according to the present invention, the depth mode DC flag indicates whether at least one of a first depth intra mode or the segment-based DC coding is used in at least one picture belonging to a current sequence, and the intra-view prediction flag indicates whether a second depth intra mode is used in at least one picture belonging to the current sequence.

In the method and apparatus for decoding a multiview video signal according to the present invention, the deriving of a prediction depth value includes deriving a prediction depth value of each partition of the current depth block based on at least one of a position or directivity of a partition line determined according to the partition pattern.

In the method and apparatus for decoding a multiview video signal according to the present invention, the current depth block is reconstructed by using the prediction depth value and a offset value (DcOffset) relating to the current depth block.

In the method and apparatus for decoding a multiview video signal according to the present invention, the reconstruction includes converting the prediction depth value of the current depth block to a first index, using the depth look-up table, calculating a second index by adding the first index to the offset value, calculating a depth value corresponding to the calculated second index, using the depth look-up table, and reconstructing the current depth block, using the calculated depth value.

In a method and apparatus for encoding a multiview video signal according to the present invention, an intra-prediction mode of a current depth block is determined, a partition pattern of the current depth block is determined according to the determined intra-prediction mode, and a prediction depth value of the current depth block is derived based on the determined partition pattern.

In the method and apparatus for encoding a multiview video signal according to the present invention, determining the intra-prediction mode comprises determining whether the current depth block uses a depth modeling mode based on at least one of a depth mode DC flag or a intra-view prediction flag, encoding, based on a depth mode DC flag or a intra-view prediction flag, adaptively DMM identification information relating to the current depth block when the current depth block uses the depth modeling mode, and determining the intra-prediction mode of the current depth block based on the encoded DMM identification information.

In the method and apparatus for encoding a multiview video signal according to the present invention, the depth mode DC flag indicates whether at least one of a first depth intra mode or the segment-based DC coding is used in at least one picture belonging to a current sequence, and the intra-view prediction flag indicates whether a second depth intra mode is used in at least one picture belonging to the current sequence.

In the method and apparatus for encoding a multiview video signal according to the present invention, the deriving of a prediction depth value includes deriving a prediction depth value of each partition of the current depth block based on at least one of a position or directivity of a partition line determined according to the partition pattern.

In the method and apparatus for encoding a multiview video signal according to the present invention, the current depth block is reconstructed by using the prediction depth value and a offset value (DcOffset) relating to the current depth block.

In the method and apparatus for encoding a multiview video signal according to the present invention, the reconstruction includes converting the prediction depth value of the current depth block to a first index, using the depth look-up table, calculating a second index by adding the first index to the offset value, calculating a depth value corresponding to the calculated second index, using the depth look-up table, and reconstructing the current depth block, using the calculated depth value.

### Advantageous Effects

According to the present invention, inter-view prediction can be efficiently performed using a disparity vector.

According to the present invention, a disparity vector of a current texture block can be effectively derived from depth data of a current depth block or a disparity vector of a neighbor texture block.

According to the present invention, intra-prediction of a depth image can be effectively performed using a depth modeling mode.

According to the present invention, the coding efficiency of an offset value can be increased using a depth look-up table, and a depth block can be reconstructed with low complexity.

According to the present invention, it is possible to effectively signal the segment DC flag for adaptively using the segment DC coding.

According to the present invention, an absolute offset value can be effectively decoded by entropy decoding based on context-based adaptive binary arithmetic coding.

### BRIEF DESCRIPTION OF THE DRAWINGS

FIG. 1 is a block diagram of a video decoder according to an embodiment to which the present invention is applied.

FIG. 2 is a flowchart depicting a method for performing inter-view prediction based on a disparity vector according to an embodiment to which the present invention is applied.

FIG. 3 is a flowchart depicting a method for deriving a disparity vector of a current texture block using depth data of a depth image according to an embodiment to which the present invention is applied.

FIG. 4 is a view depicting candidates for a spatial/temporal neighbor block of a current texture block according to an embodiment to which the present invention is applied.

FIG. 5 is a flowchart depicting a method for reconstructing a current depth block encoded in an intra mode according to an embodiment to which the present invention is applied.

FIG. 6 illustrates a condition for using a syntax function related to a depth modeling mode according to an embodiment to which the present invention is applied.

FIG. 7 is a table depicting a syntax of a depth modeling mode of a current depth block according to an embodiment to which the present invention is applied.

FIG. 8 is a view depicting a method for deriving a prediction depth value of each partition included in a current depth block according to an embodiment to which the present invention is applied.

FIG. 9 is a flowchart depicting a method for correcting a prediction depth value of a current depth block using an offset value, DcOffset according to an embodiment to which the present invention is applied.

FIG. 10 is a method depicting a method for acquiring an absolute offset value by entropy decoding based on context-based adaptive binary arithmetic coding according to an embodiment to which the present invention is applied.

FIGS. 11, 12 and 13 are tables depicting a method for binarizing an absolute offset value according to a maximum number of bins, cMax according to an embodiment to which the present invention is applied.

### BEST MODE

In a method and apparatus for decoding a multiview video signal according to the present invention, an intra-prediction mode of a current depth block is determined, a partition pattern of the current depth block is determined according to the determined intra-prediction mode, and a prediction depth value of the current depth block is derived based on the determined partition pattern

In the method and apparatus for decoding a multiview video signal according to the present invention, determining the intra-prediction mode comprises determining whether the current depth block uses a depth modeling mode based on at least one of a depth mode DC flag or a intra-view prediction flag, obtaining, based on a depth mode DC flag or a intra-view prediction flag, adaptively DMM identification information relating to the current depth block from the bit stream when the current depth block uses the depth modeling mode, and determining the intra-prediction mode of the current depth block based on the obtained DMM identification information.

In the method and apparatus for decoding a multiview video signal according to the present invention, the depth mode DC flag indicates whether at least one of a first depth intra mode or the segment-based DC coding is used in at least one picture belonging to a current sequence, and the intra-view prediction flag indicates whether a second depth intra mode is used in at least one picture belonging to the current sequence.

In the method and apparatus for decoding a multiview video signal according to the present invention, the deriving of a prediction depth value includes deriving a prediction depth value of each partition of the current depth block based on at least one of a position or directivity of a partition line determined according to the partition pattern.

In the method and apparatus for decoding a multiview video signal according to the present invention, the current depth block is reconstructed by using the prediction depth value and a offset value (DcOffset) relating to the current depth block.

In the method and apparatus for decoding a multiview video signal according to the present invention, the reconstruction includes converting the prediction depth value of the current depth block to a first index, using the depth look-up table, calculating a second index by adding the first index to the offset value, calculating a depth value corresponding to the calculated second index, using the depth look-up table, and reconstructing the current depth block, using the calculated depth value.

In a method and apparatus for encoding a multiview video signal according to the present invention, an intra-prediction mode of a current depth block is determined, a partition pattern of the current depth block is determined according to the determined intra-prediction mode, and a prediction depth value of the current depth block is derived based on the determined partition pattern.

In the method and apparatus for encoding a multiview video signal according to the present invention, determining the intra-prediction mode comprises determining whether the current depth block uses a depth modeling mode based on at least one of a depth mode DC flag or a intra-view prediction flag, encoding, based on a depth mode DC flag or a intra-view prediction flag, adaptively DMM identification information relating to the current depth block when the current depth block uses the depth modeling mode, and determining the intra-prediction mode of the current depth block based on the encoded DMM identification information.

In the method and apparatus for encoding a multiview video signal according to the present invention, the depth mode DC flag indicates whether at least one of a first depth intra mode or the segment-based DC coding is used in at least one picture belonging to a current sequence, and the intra-view prediction flag indicates whether a second depth intra mode is used in at least one picture belonging to the current sequence.

In the method and apparatus for encoding a multiview video signal according to the present invention, the deriving of a prediction depth value includes deriving a prediction depth value of each partition of the current depth block based on at least one of a position or directivity of a partition line determined according to the partition pattern.

In the method and apparatus for encoding a multiview video signal according to the present invention, the current depth block is reconstructed by using the prediction depth value and a offset value (DcOffset) relating to the current depth block.

In the method and apparatus for encoding a multiview video signal according to the present invention, the reconstruction includes converting the prediction depth value of the current depth block to a first index, using the depth look-up table, calculating a second index by adding the first index to the offset value, calculating a depth value corresponding to the calculated second index, using the depth look-up table, and reconstructing the current depth block, using the calculated depth value.

### MODE FOR CARRYING OUT THE INVENTION

In a technique for compressing or decompressing a multiview video signal, spatial redundancy, temporal redundancy, and inter-view redundancy is considered. In the case of a multiview image, multiview texture images captured from two or more viewpoints may be encoded to achieve a Three-Dimensional (3D) image. When needed, depth data corresponding to the multiview texture images may further be encoded. Obviously, the depth data may be encoded in consideration of spatial redundancy, temporal redundancy, or inter-view redundancy. Depth data is a representation of distance information between a camera and a corresponding pixel. In the present disclosure, depth data may be flexibly interpreted as information related to a depth, such as a depth value, depth information, a depth image, a depth picture, a depth sequence, and a depth bit stream. In the present disclosure, coding may cover both encoding and decoding in concept and may be flexibly interpreted according to the scope and spirit of the present invention.

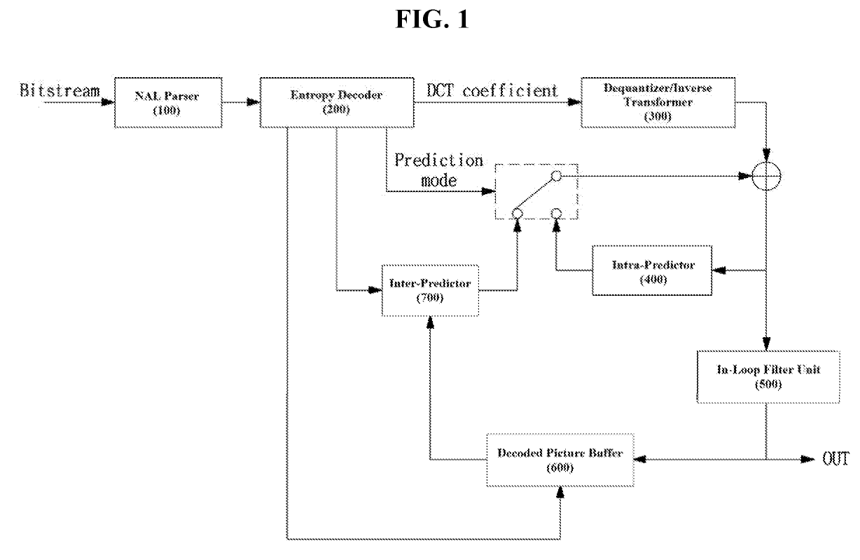

FIG. 1 is a block diagram of a video decoder according to an embodiment to which the present invention is applied.

Referring to FIG. 1, the video decoder may include a Network Abstraction Layer (NAL) parser 100, an entropy decoder 200, a dequantizer/inverse transformer 300, an intra-predictor 400, an in-loop filter unit 500, a decoded picture buffer 600, and an inter-predictor 700.

The NAL parser 100 may receive a bit stream including multiview texture data. If depth data is required for coding of the texture data, a bit stream including encoded depth data may further be received. The input texture data and depth data may be transmitted in one bit stream or separate bit streams. The NAL parser 100 may parse the input bit stream on a NAL basis to decode the input bit stream. If the input bit stream is multiview-related data (e.g., a Three-Dimensional (3D) video), the input bit stream may further include a camera parameter. Camera parameters may include an intrinsic camera parameter and an extrinsic camera parameter. The intrinsic camera parameter may include a focal length, an aspect ratio, a principal point, and so on. The extrinsic camera parameter may include position information about a camera in the global coordinate system.

The entropy decoder 200 may extract quantized transform coefficients and coding information for prediction of a texture picture through entropy decoding.

The dequantizer/inverse transformer 300 may acquire transform coefficients by applying a quantization parameter to the quantized transform coefficients, and decode texture data or depth data by inverse-transforming the transform coefficients. Herein, the decoded texture data or depth data may refer to residual data resulting from prediction processing. A quantization parameter for a depth block may be set in consideration of the complexity of texture data. For example, a low quantization parameter may be set for an area in which a texture block corresponding to a depth block has high complexity, and a high quantization parameter may be set for an area in which a texture block corresponding to a depth block has low complexity. The complexity of a texture block may be determined based on a difference between adjacent pixels in a reconstructed texture picture by [Equation 1].

$$E = \frac{1}{N} {\sum }_{( x , y )} {[ \vert {C}_{x , y} - {C}_{x - 1 , y} \vert + \vert {C}_{x , y} - {C}_{x + 1 , y} \vert ]}^{2} \qquad [ Equation 1 ]$$

In [Equation 1], E may represent the complexity of texture data, C may represent reconstructed texture data, and N may represent the number of pixels in a texture data area whose complexity is to be calculated. Referring to [Equation 1], the complexity of texture data may be calculated using a difference between texture data at position (x, y) and texture data at position (x−1, y), and a difference between the texture data at position (x, y) and texture data at position (x+1, y). Further, the complexity of each of a texture picture and a texture block may be calculated, and a quantization parameter may be derived from the complexity by [Equation 2].

$$Δ QP = min ( max ( α {log}_{2} \frac{{E}_{f}}{{E}_{b}} , - β ) , β ) \qquad [ Equation 2 ]$$

Referring to [Equation 2], a quantization parameter for a depth block may be determined based on a ratio between the complexity of a texture picture and the complexity of a texture block. α and β may be variable integers derived by a decoder or predetermined integers in the decoder.

The intra-predictor 400 may perform intra-prediction using the reconstructed texture data in the current texture picture. A depth picture may be intra-predicted in the same manner as the texture picture. For example, the same coding information as used for intra-prediction of the texture picture may be used for the depth picture. Herein, the coding information used for intra-prediction may include an intra-prediction mode and partition information for intra-prediction.

The in-loop filter unit 500 may apply an in-loop filter to each coded block in order to reduce block distortion. The filter may increase the video quality of a decoded picture by smoothing edges of a block. Filtered texture pictures or depth pictures may be output or stored in the decoded picture buffer 600, for use as reference pictures. Meanwhile, if texture data and depth data are encoded using the same in-loop filter, coding efficiency may be decreased because the texture data and the depth data have different characteristics. Accordingly, an in-loop filter may be defined separately for depth data. Hereinbelow, a region-based adaptive loop filter and a trilateral loop filter will be described as in-loop filtering methods for efficiently coding depth data.

In the case of a region-based adaptive loop filter, it may be determined whether to apply the region-based adaptive loop filter based on a variance of a depth block. The variance of the depth block may be defined as a difference between a maximum pixel value and a minimum pixel value in the depth block. It may be determined whether to apply the filter by comparing the variance of the depth block with a predetermined threshold. For example, if the variance of the depth block is equal to or larger than the predetermined threshold, which implies that the difference between the maximum and minimum pixel values of the depth block is large, it may be determined to apply the region-based adaptive loop filter. On the contrary, if the variance of the depth block is less than the predetermined threshold, it may be determined not to apply the region-based adaptive loop filter. If the filter is applied according to the comparison result, a pixel value of the filtered depth block may be derived by applying a predetermined weight to a neighbor pixel value. The predetermined weight may be determined based on a difference between the positions of the current filtered pixel and the neighbor pixel and/or the difference between the values of the current filtered pixel and the neighbor pixel. Further, the neighbor pixel value may mean one of pixels values included in the depth block, except for the current filtered pixel value.

Although similar, the trilateral loop filter according to the present invention is different from the region-based adaptive loop filter in that the former additionally considers texture data. Specifically, the trilateral loop filter may extract depth data of a neighbor pixel satisfying the following three conditions.

|p−q|≦σ1 Condition 1:

|D(p)−D(q)|≦σ2 Condition 2:

|V(p))−V(q)|≦σ3 Condition 3:

In Condition 1, a position difference between a current pixel p and a neighbor pixel q in a depth block is compared with a predetermined parameter σ1. In Condition 2, a difference between depth data of the current pixel p and depth data of the neighbor pixel q is compared with a predetermined parameter σ2. In Condition 3, a difference between texture data of the current pixel p and texture data of the neighbor pixel q is compared with a predetermined parameter σ3.

Neighbor cells satisfying the above three conditions may be extracted, and the current pixel p may be filtered to the median value or mean value of the depth data of the neighbor pixels.

The decoded picture buffer 600 functions to store or open previously coded texture pictures or depth pictures, for inter-prediction. Each of the previously coded texture pictures or depth pictures may be stored or opened in the decoded picture buffer 600, using the frame number, frame_num, and Picture Order Count (POC) of the picture. Further, since there are depth pictures of different views from that of a current depth picture among the previously coded pictures, view identification information indicating the views of these depth pictures may be used to use the depth pictures as reference pictures, during depth coding. The decoded picture buffer 600 may manage reference pictures by an adaptive memory management control operation method, a sliding window method, and so on, for more flexible inter-prediction. This operation is performed in order to incorporate a memory for reference pictures and a memory for non-reference pictures into a single memory and efficiently manage the pictures with a small memory capacity. In depth coding, depth pictures may be marked with a separate indication to be distinguished from texture pictures in the decoded picture buffer, and information identifying each depth picture may be used during the marking.

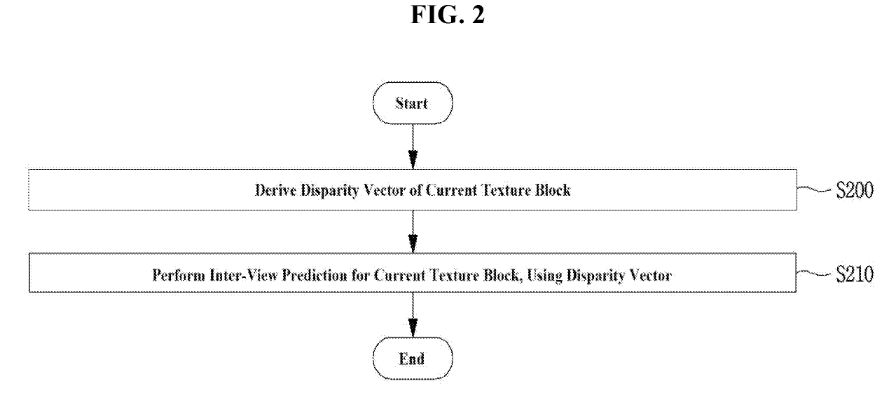

The inter-predictor 700 may perform motion compensation on the current block using a reference picture stored in the decoded picture buffer 600, and motion information. In the present disclosure, it may be understood that motion information includes a motion vector, a reference index, and so on in its broad sense. The inter-predictor 700 may perform temporal inter-prediction to perform the motion compensation. Temporal inter-prediction may refer to inter-prediction based on a reference picture which has the same view as a current texture block and positioned at a different time from the current texture block, and motion information of the current texture block. In the case of a multiview image captured by a plurality of cameras, inter-view prediction as well as temporal inter-prediction may be performed. Motion information used for the inter-view prediction may include a disparity vector or an inter-view motion vector. A method for performing inter-view prediction using a disparity vector will be described below with reference to FIG. 2.

FIG. 2 is a flowchart depicting a method for performing inter-view prediction based on a disparity vector according to an embodiment to which the present invention is applied.

Referring to FIG. 2, a disparity vector of a current texture block may be derived (S200).

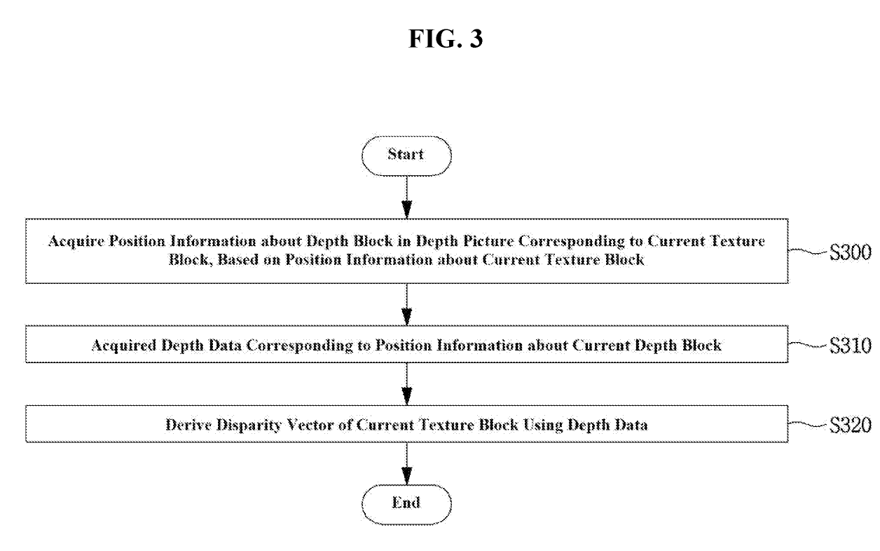

For example, the disparity vector may be derived from a depth image corresponding to the current texture block, which will be described in detail with reference to FIG. 3.

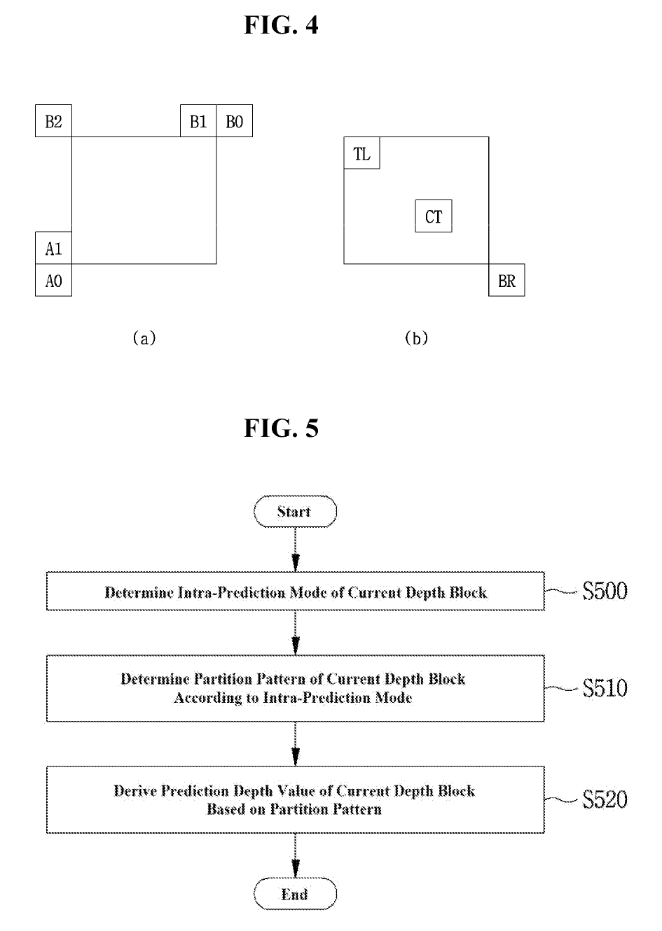

The disparity vector may also be derived from a neighbor block spatially adjacent to the current texture block, and from a temporal neighbor block at a different time from the current texture block. A method for deriving a disparity vector from a spatial/temporal neighbor block of a current texture block will be described with reference to FIG. 4.

Referring to FIG. 2, inter-view prediction may be performed for the current texture block, using the disparity vector derived in step S200 (S210).

For example, texture data of the current texture block may be predicted or reconstructed using texture data of a reference block specified by the disparity vector. Herein, the reference block may belong to a view used for inter-view prediction of the current texture block, that is, a reference view. The reference block may belong to a reference picture positioned at the same time as the current texture block.

Further, a reference block of the reference view may be specified using the disparity vector, and a temporal motion vector of the current texture block may be derived using a temporal motion vector of the specified reference block. The temporal motion vector refers to a motion vector used for temporal inter-prediction, and may be distinguished from a disparity vector used for inter-view prediction.

FIG. 3 is a flowchart depicting a method for deriving a disparity vector of a current texture block using depth data of a depth image according to an embodiment to which the present invention is applied.

Referring to FIG. 3, position information about a depth block (hereinafter, referred to a current depth block) in a depth picture corresponding to a current texture block may be acquired based on position information about the current texture block (S300).

The position of the current depth block may be determined in consideration of the spatial resolutions of the depth picture and the current picture.

For example, if the depth picture and the current picture are coded with the same spatial resolution, the position of the current depth block may be determined to be the position of the current texture block in the current picture. Meanwhile, the current picture and the depth picture may be encoded with different spatial resolutions. In view of the nature of depth information representing a distance between a camera and an object, coding of the depth information with a reduced spatial resolution may not decrease coding efficiency greatly. Therefore, if the spatial resolution of the depth picture is coded to be lower than that of the current picture, the decoder may upsample the depth picture before acquiring the position information about the current depth block. Further, if the aspect ratio of the upsampled depth picture does not accurately match to the aspect ratio of the current picture, offset information may be additionally considered in acquiring the information about the position of the current depth block in the upsampled depth picture. The offset information may include at least one of upper offset information, left offset information, right offset information, and lower offset information. The upper offset information may indicate a position difference between at least one pixel above the upsampled depth picture and at least one pixel above the current picture. The left, right, and lower offset information may also be defined in the same manner.

Referring to FIG. 3, depth data corresponding to position information about a current depth block may be acquired (S310).

If there are a plurality of pixels in the current depth block, depth data corresponding to a corner pixel of the current depth block may be used. Or depth data corresponding to a center pixel of the current depth block may be used. Or one of the maximum, minimum, and mode values of a plurality of depth data corresponding to the plurality of pixels may be selectively used, or the mean value of the plurality of depth data may be used.

Referring to FIG. 3, a disparity vector of a current texture block may be derived using the depth data acquired in step S310 (S320).

For example, the disparity vector of the current texture block may be derived by [Equation 3].

DV=(a*v+f) [symbol] n [Equation 3]

Referring to [Equation 3], v represents depth data, a represents a scaling factor, and f represents an offset used to derive a disparity vector. The scaling factor a and the offset f may be signaled in a video parameter set or a slice header, or may be preset in the decoder. Herein, n is a parameter indicating a bit shift value, which may be determined variably according to the accuracy of the disparity vector.

FIG. 4 is a view depicting candidates for a spatial/temporal neighbor block of a current texture block according to an embodiment to which the present invention is applied.

Referring to FIG. 4(a), the spatial neighbor block may be at least one of a left neighbor block A1, an upper neighbor block B1, a lower left neighbor block A0, an upper right neighbor block B0, or an upper left neighbor block B2 of the current texture block.

Referring to FIG. 4(b), the temporal neighbor block may refer to a block at the same position as the current texture block. Specifically, the temporal neighbor block is a block belonging to a picture at a different time from the current texture block. The temporal neighbor block may be at least one of a block BR corresponding to a lower right pixel of the current texture block, a block CT corresponding to a center pixel of the current texture block, or a block TL corresponding to an upper left pixel of the current texture block.

A disparity vector of the current texture block may be derived from a Disparity-Compensated Prediction (DCP) block among the above spatial/temporal neighbor blocks.

The DCP block may be a block encoded by inter-view texture prediction using a disparity vector. In other words, inter-view prediction may be performed for the DCP block, using texture data of a reference block specified by the disparity vector. In this case, the disparity vector of the current texture block may be predicted or reconstructed using the disparity vector that the DCP block has used for the inter-view texture prediction.

Or the disparity vector of the current texture block may be derived from a Disparity Vector-based Motion Compensation Prediction (DV-MCP) block among the spatial neighbor blocks. The DV-MCP block may be a block encoded by inter-view motion prediction using a disparity vector. In other words, temporal inter-prediction may be performed for the DV-MCP block, using a temporal motion vector of a reference block specified by the disparity vector. In this case, the disparity vector of the current texture block may be predicted or reconstructed using the disparity vector that the DV-MCP block has used to acquire the temporal motion vector of the reference block.

For the current texture block, it may be determined whether the spatial/temporal neighbor blocks are DCP blocks according to their predetermined priority levels, and the disparity vector of the current texture block may be derived from the first detected DCP block. For example, the neighbor blocks may be prioritized preliminarily in the order of spatial neighbor blocks>temporal neighbor blocks, and it may be determined whether the spatial neighbor blocks are DCP blocks in the priority order of A1->B1->B0->A0->B2. However, the prioritization is a mere embodiment, and it is obvious that the neighbor blocks may be prioritized in a different manner within the scope apparent to those skilled in the art.

If none of the spatial/temporal neighbor blocks are DCP blocks, it may be additionally checked whether the spatial neighbor blocks are DV-MCP blocks. Likewise, the disparity vector may be derived from the first detected DV-MCP block.

The segment-wise DC coding is a technique for encoding residual signals relating to a depth image (e.g., coding block or prediction block) into one residual signal (hereinafter, referred to as offset value (DcOffset)) representing all pixels without encoding each pixel. One depth image may be composed of at least one segment or a partition. If the depth image is composed of two or more segments, one offset value (DcOffset) may be encoded for each segment. When the above-described segment-based depth coding technique is used, at least one of the inverse quantization or inverse transform for the coded residual signal may be skipped, and the bit rate may be significantly reduced compared to the case of coding the residual signal for each pixel.

In the encoder, the offset value (DcOffset) may be derived by averaging the difference between the original depth value and the prediction depth value. For example, the difference value between the original depth value and the prediction depth value may be obtained for each pixel of the depth image, and an average value of the obtained difference values may be defined as an offset value (DcOffset). Alternatively, the average value of the original depth values of the depth image and the average value of the prediction depth values may be calculated respectively, and the difference value between the average values may be defined as the offset value (DcOffset). The offset value (DcOffset) determined in the encoder may be encoded in the form of an offset absolute value (depth_dc_abs) and offset sign information (depth_dc_sign_flag) and transmitted to the decoder. Hereinafter, a method of reconstructing the depth image based on a segment-based depth coding technique in a decoder will be described with reference to FIGS. 5 to 13.

FIG. 5 is a flowchart depicting a method for reconstructing a current depth block encoded in an intra mode according to an embodiment to which the present invention is applied.

Referring to FIG. 5, an intra-prediction mode of a current depth block may be determined (S500).

An intra-prediction mode used for intra-prediction of a texture image (hereinafter, referred to as a Texture Modeling Mode TMM)) may be used as the intra-prediction mode of the current depth block. For example, an intra-prediction mode as defined in the High Efficiency Video Coding (HEVC) standard (Planar mode, DC mode, Angular mode, and so on) may be used as the intra-prediction mode of a depth image.

Specifically, a decoder may derive the intra-prediction mode of the current depth block based on a candidate list and a mode index. The candidate list may include a plurality of candidates available as the intra-prediction mode of the current depth block. The plurality of candidates include an intra-prediction mode of a neighbor block to the left and/or above the current depth block, a predefined intra-prediction mode, and so on. Because a depth image is less complex than a texture image, the maximum number of candidates included in a candidate list may be set to be different for the texture image and the depth image. For example, a candidate list for a texture image may list up to three candidates, whereas a candidate list for a depth image may list up to two candidates. The mode index is information specifying one of the plurality of candidates included in the candidate list, and may be encoded to specify the intra-prediction mode of the current depth block.

Meanwhile, compared to a texture image, a depth image may be configured with the same or similar values in some cases. If the afore-described TMM is also used for the depth image, coding efficiency may be decreased. Therefore, it is necessary to use an intra-prediction mode for a depth image separately from an intra-prediction mode for a texture image. This intra-prediction mode defined to efficiently model a depth image is referred to as a Depth Modeling Mode (DMM).

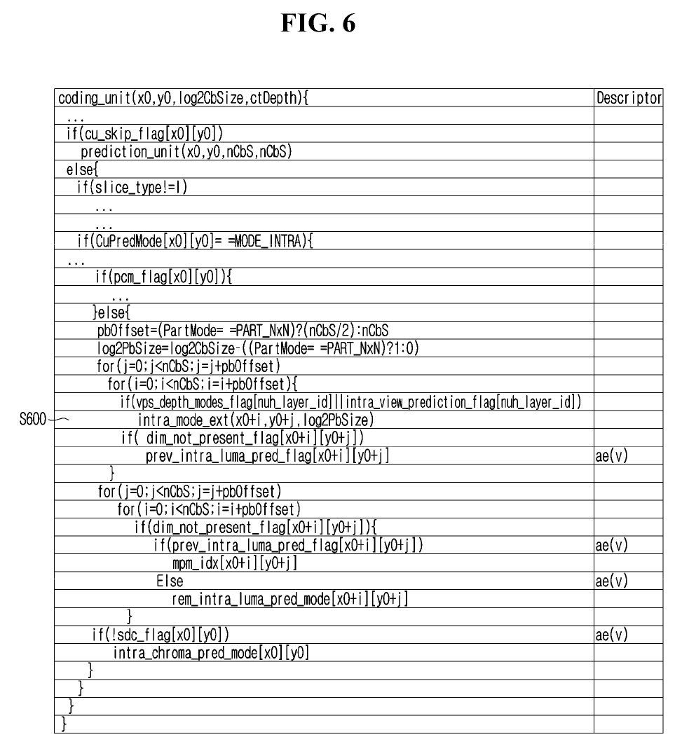

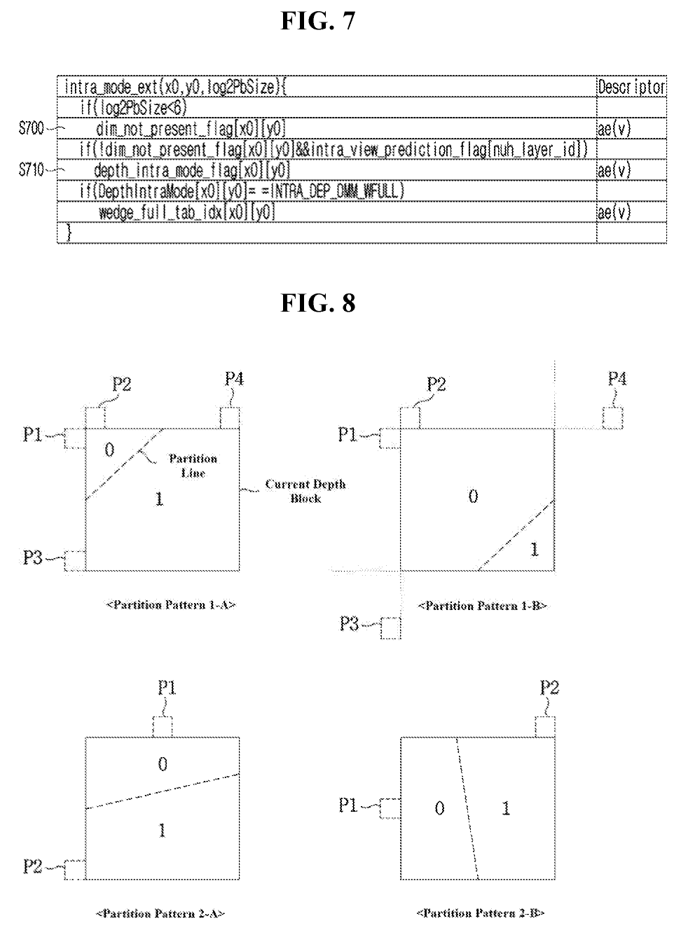

DMMs may be classified into a first depth intra mode (hereinafter, referred to as DMM1) in which intra-prediction is performed according to a partition pattern based on the start position and end position of a partition line, a second depth intra mode (hereinafter, referred to as DMM4) in which intra-prediction is performed through partitioning based on a reconstructed texture block, and so on. A method for determining a DMM for a current depth block will be described with reference to FIGS. 6 to 7.

Referring to FIG. 5, a partition pattern of a current depth block may be determined according to the intra-prediction mode determined in step S500 (S510). Now, a description will be given of methods for determining a partition pattern for each intra-prediction mode.

(1) Case of Encoding Current Depth Block in the First Depth Intra Mode

In the first depth intra mode, a depth block may have various partition patterns according to a partition line connecting a start position to an end position. The start/end position may correspond to any of a plurality of sample positions at a boundary of the depth block. The start position and the end position may be positions at different boundaries. The plurality of sample positions at the boundary of the depth block may have a specific accuracy. For example, the start/end position may have an accuracy in units of two samples, a full sample, or a half sample.

The accuracy of the start/end position may depend on the size of the depth block. For example, if the depth block is of size 32×32 or 16×16, the accuracy of the start/end position may be limited to units of two samples. If the depth block is of size 8×8 or 4×4, the accuracy of the start/end position may be limited to units of a full sample or a half sample.

A plurality of partition patterns available for a depth block may be generated by combining one sample position with another sample position at boundaries of the depth block. A partition pattern may be determined by selecting one of a plurality of partition patterns based on a pattern index. For this purpose, a table defining a mapping relationship between pattern indexes and partition patterns may be used. A pattern index may be an encoded identifier identifying one of the plurality of partition patterns. The depth block may be divided into one or more partitions according to the determined partition pattern.

(2) Case of Encoding Current Depth Block in the Second Depth Intra Mode

In the second depth intra mode, a partition pattern for a depth block may be determined by comparing a reconstructed texture value of a texture block with a predetermined threshold value. The texture block may be a block at the same position as the depth block. The predetermined threshold value may be determined to be the mean value, mode value, minimum value, or maximum value of samples at corners of the texture block. The samples at the corners of the texture block may include at least two of a left-upper corner sample, a right-upper corner sample, a left-lower corner sample, and a right-lower corner sample.

The texture block may be divided into a first area and a second area by comparing the reconstructed texture value of the texture block with the predetermined threshold. The first area may be a set of samples having larger texture values than the predetermined threshold, and the second area may be a set of samples having smaller texture values than the predetermined threshold. To distinguish the first area from the second area, 1s may be allocated to the samples of the first area, and 0s may be allocated to the samples of the second area. The opposite case is also possible. That is, 0s may be allocated to the samples of the first area, and 1s may be allocated to the samples of the second area. A partition pattern for the depth block may be determined in correspondence with the first area and the second area of the texture block. The depth block may be divided into two or more partitions according to the determined partition pattern.

(3) Case of Encoding Current Depth Block in TMM

If a current depth bock is encoded in the TMM, the current depth block may include one partition. The decoder may allocate the same constant to all samples of the current depth block to indicate that the current depth block includes one partition. For example, 0 may be allocated to each sample of the current depth block.

Referring to FIG. 5, a prediction depth value of the current depth block may be derived based on the partition pattern determined in step S510 (S520).

Specifically, if the current depth block is encoded in a DMM, a prediction depth value of each partition obtained by dividing the depth block according to the partition pattern using samples around the current depth block may be derived. A method for deriving the prediction depth value of each partition will be described in detail with reference to FIG. 8.

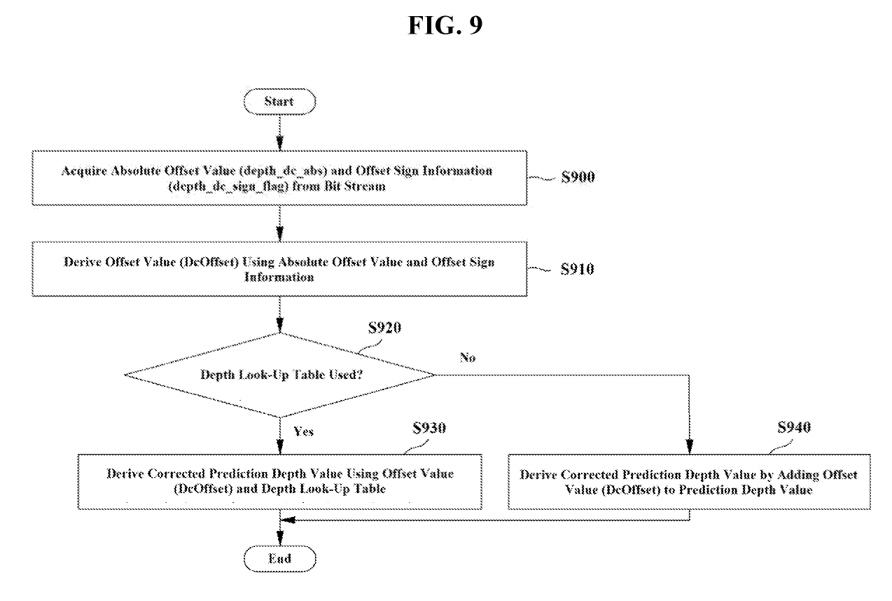

Or if the current depth block is encoded in the TMM, the prediction depth value of the current depth block may be derived using samples around the current depth block in a corresponding intra-prediction mode, that is, the Planar mode, the DC mode, or the Angular mode. The mean value of four prediction depth values at corners of the current depth block may be calculated, and the current depth block may be reconstructed using the calculated mean value and a depth look-up table. For example, a pixel-domain mean value may be converted to an index using a function DltValToIdx[ ], and an index may be converted to a corresponding depth value using a function DltIdxToVal[ ]. The depth value obtained by the function DltIdxToVal[ ] may be set as the reconstructed depth value of the current depth block. With reference to FIG. 9, a depth look-up table will be described later.

Meanwhile, to increase prediction accuracy, a prediction depth value may be corrected or a reconstructed depth value may be derived, by applying an offset value to a prediction depth value of each partition, which will be described in detail with reference to FIG. 9.

FIG. 6 illustrates a condition for using a syntax function related to a depth modeling mode according to an embodiment to which the present invention is applied.

The syntax function, intra mode ext (x0+i, y0+j, log 2Psize), may be used to determine the depth modeling mode of the current depth block.

Referring to FIG. 6, the syntax function, intra mode ext ( ) may be called based on at least one of the depth mode DC flag (vps_depth_modes_flag) and the intra view prediction flag (intra_view_prediction_flag) (S600).

The depth mode DC flag may indicate whether at least one of the DMM1 or the segment based DC coding technique is used in the current layer or sequence. For example, if the value of the depth mode DC flag is 1, it may indicate that at least one of DMM1 or segment based DC coding technique is used in at least one picture belonging to the current layer or sequence. If the value of the depth mode DC flag is 0, It may indicate that DMM1 and segment-based DC coding technique are not used in all of the pictures belonging to the current layer or sequence.

The intra-view prediction flag may indicate whether intra-view prediction is used in the current layer or sequence. For example, when the value of the intra-view prediction flag is 1, it may indicate that DMM4 is used in at least one picture belonging to the current layer or sequence. If the value of the intra-view prediction flag is 0, it may indicate that DMM4 is not used in all of the pictures belonging to the current layer or sequence.

The depth mode DC flag and the intra view prediction flag may be encoded in the encoder and transmitted to the decoder. Alternatively, it may be derived as a pre-determined value by considering the picture type of the current picture.

Specifically, the picture type includes an instantaneous decoding refresh (IDR) picture, a broken link access (BLA) picture, and a clean random access (CRA) picture.

The IDR picture refers to a picture that may not refer to a previously decoded picture by initializing a decoded picture buffer (DPB).

A picture which is decoded after the random access picture but whose output order is ahead of the random access picture is referred to as a leading picture for a random access picture. Herein, the output order may be determined based on POC (picture order count) information. The leading picture may refer to at least one of the decoded picture prior to the random access picture and the random access picture, and the random access picture at this time is referred to as the CRA picture.

The case where a picture referred to by the leading picture is not available for reference (For example, bitstream splicing) may occur, and a random access picture for this leading picture is referred to as a BLA picture.

The picture type of the current depth picture may be identified by nal_unit_type. Herein, nal_unit_type may be signaled for the current depth picture. Alternatively, the signaled nal_unit_type for the current texture picture may be applied equally to the current depth picture. Specifically, when the nal_unit_type of the current depth picture is the IDR picture, the decoded picture buffer is initialized so that the picture decoded before the current picture can not be referred to. Therefore, when nal_unit_type is an IDR picture, the DMM 4 may not be used because the DMM 4 uses the texture picture decoded before the current depth picture can not be used.

Also, when nal_unit_type is BLA picture, some of the previously decoded pictures are removed from the decoded picture buffer and can not be referenced. If the previously decoded texture information is removed from the decoded picture buffer, there is a problem that the current depth block can not be restored using the DMM 4. Therefore, even if nal_unit_type is BLA picture, the usage of the DMM4 can be restricted.

Therefore, when nal_unit_type is an IDR picture or a BLA picture, the value of the intra_view_prediction_flag is not signaled and its value may be set equal to 0.

Referring to FIG. 6, the syntax function, intra mode ext ( ) may be used when at least one of the depth mode DC flag and the intra_view_prediction_flag is 1. Hereinafter, a method of determining the depth modeling mode of the current depth block using the syntax function, intra mode ext ( ) will be described with reference to FIG. 7.

FIG. 7 is a table depicting a syntax of a DMM of a current depth block according to an embodiment to which the present invention is applied.

Referring to FIG. 7, it may be determined whether a current depth block uses a DMM (S700).

Specifically, it may be determined whether the current block uses the DMM based on a depth intra mode flag, dim_not_present_flag. The depth intra mode flag is an encoded syntax indicating whether the current depth block uses the DMM. For example, if the depth intra mode flag is 0, this may indicate that the current depth block uses the DMM, and if the depth intra mode flag is 1, this may indicate that the current depth block does not use the DMM. When the value of the depth intra mode flag is 1, the above-described texture modeling mode, that is, the intra prediction mode predefined by the HEVC standard, may be used. The depth intra mode flag may be signaled on a picture basis, a slice basis, a slice segment basis, an intra prediction mode basis, or a block basis.

It may be determined whether the current block uses the DMM, depending on the size of the current depth block. Only when the size of the current depth block is smaller than a threshold size among predefined block sizes, it may be determined whether the current block uses the DMM. The threshold size may be the minimum of block sizes for which use of the DMM is restricted, and may be preset by the decoder. For example, if the threshold size is 64×64, only when the size of the current depth block is smaller than 64×64, the depth intra mode flag may be signaled, and otherwise, the depth intra mode flag may be set to 0, without being signaled.

Referring to FIG. 7, if it is determined that the current depth block uses the DMM in step S700, DMM identification information (depth_intra_mode_flag) may be acquired from a bit stream (S710).

The DMM identification information may indicate whether the current depth block uses the first depth intra mode (DMM1) or second depth intra mode (DMM4). For example, if the value of the DMM identification information is 0, this may indicate that the first depth intra mode is used, and if the value of the DMM identification information is 1, this may indicate that the second depth intra mode is used.

The DMM identification information may be adaptively obtained based on at least one of a depth mode DC flag and an intra view prediction flag.

For example, when the value of the depth mode DC flag is 0, the DMM identification information is not signaled, and the intra prediction mode of the current depth block may be set equal to DMM4. That is, when the value of the depth mode DC flag is 0, the DMM identification information is not obtained from the bit stream, and the value of the DMM identification information may be set equal to 1 in the decoder.

The DMM identification information is not signaled even if the value of the intra view prediction flag is 0 and the intra prediction mode of the current depth block may be set equal to DMM1. That is, when the value of the intra-view prediction flag is 0, the DMM identification information is not obtained from the bit stream, and the value of the DMM identification information may be set equal to 0 in the decoder.

The DMM identification information may be obtained from the bit stream when the depth mode DC flag and the intra_view_prediction_flag are not 0. The intra prediction mode of the current depth block may be determined based on the obtained DMM identification information.

FIG. 8 is a view depicting a method for deriving a prediction depth value of each partition in a current depth block according to an embodiment to which the present invention is applied.

A prediction depth value of each partition may be derived in consideration of a partition pattern of a current depth block. That is, the prediction depth value of each partition may be derived in consideration of at least one of the position or directivity of a partition line dividing the current depth block. The directivity of the partition line may mean whether the partition line is vertical or horizontal.

Referring to FIG. 8, in a partition pattern 1-A, the current depth block is divided by a partition line which starts from one of an upper boundary and a left boundary of the current depth block and ends on the other boundary.

In this case, a prediction depth value dcValLT of partition 0 may be determined to be the mean value, maximum value, or minimum value of a first adjacent depth sample P1 to the left of partition 0 and a second adjacent depth sample P2 above partition 0. For example, the first depth sample P1 may be the uppermost of a plurality of adjacent samples to the left of partition 0, and the second depth sample P2 may be the leftmost of a plurality of adjacent samples above partition 0.

A prediction depth value dcValBR of partition 1 may be determined to be the mean value, maximum value, or minimum value of a third adjacent depth sample P3 to the left of partition 1 and a fourth adjacent depth sample P4 above partition 1. For example, the third depth sample P3 may be the lowermost of a plurality of adjacent samples to the left of partition 1, and the fourth depth sample P4 may be the rightmost of a plurality of adjacent samples above partition 1.

Referring to FIG. 8, in a partition pattern 1-B, the current depth block is divided by a partition line which starts from one of a lower boundary and a right boundary of the current depth block and ends on the other boundary.

In this case, a prediction depth value dcValLT of partition 0 may be determined to be the mean value, maximum value, or minimum value of a first adjacent depth sample P1 to the left of partition 0 and a second adjacent depth sample P2 above partition 0. For example, the first depth sample P1 may be the uppermost of a plurality of adjacent samples to the left of partition 0, and the second depth sample P2 may be the leftmost of a plurality of adjacent samples above partition 0.

A prediction depth value dcValBR of partition 1 may be determined based on a comparison between a vertical difference verAbsDiff and a horizontal difference horAbsDiff. The vertical difference may be the difference between the first depth sample and one (referred to as a third depth sample P3) of depth samples in a left lower area adjacent to the current depth block. The horizontal difference may be the difference between the second depth sample and one (referred to as a fourth depth sample P4) of depth samples in a right upper area adjacent to the current depth block. If the vertical difference is larger than the horizontal difference, the prediction depth value of partition 1, dcValBR may be derived from a reconstructed depth value of the third depth sample P3. On the contrary, if the horizontal difference is larger than the vertical difference, the prediction depth value of partition 1, dcValBR may be derived from a reconstructed depth value of the fourth depth sample P4.

Referring to FIG. 8, in a partition pattern 2-A, the current depth block is divided by a partition line which starts from one of the left boundary and the right boundary of the current depth block and ends on the other boundary.

In this case, a prediction depth value dcValLT of partition 0 may be derived from a reconstructed depth value of a first adjacent depth sample P1 above partition 0. For example, the first depth sample P1 may be a center, leftmost, or rightmost one of a plurality of adjacent samples above partition 0. A prediction depth value dcValBR of partition 1 may be derived from a reconstructed depth value of a second adjacent depth sample P2 to the left of partition 1. For example, the second depth sample P2 may be the lowermost of a plurality of adjacent samples to the left of partition 1.

While not shown in FIG. 8, when the current depth block is divided by a partition line starting from one of the left boundary and the lower boundary of the current depth block and ending on the other boundary, the prediction depth value of each partition may also be derived in the same manner as in the afore-described partition pattern 2-A.

Referring to FIG. 8, in a partition pattern 2-B, the current depth block is divided by a partition line which starts from one of the upper boundary and the lower boundary of the current depth block and ends on the other boundary.

In this case, a prediction depth value dcValLT of partition 0 may be derived from a reconstructed depth value of a first adjacent depth sample P1 to the left of partition 0. For example, the first depth sample P1 may be a center, uppermost, or lowermost one of a plurality of adjacent samples to the left of partition 0. A prediction depth value dcValBR of partition 1 may be derived from a reconstructed depth value of a second adjacent depth sample P2 above partition 1. For example, the second depth sample P2 may be the leftmost of a plurality of adjacent samples above partition 1.

While not shown in FIG. 8, when the current depth block is divided by a partition line starting from one of the upper boundary and the right boundary of the current depth block, the prediction depth value of each partition may also be derived in the same manner as in the afore-described partition pattern 2-B.

FIG. 9 is a flowchart illustrating a method for correcting a prediction depth value of a current depth block using an offset value, DcOffset according to an embodiment to which the present invention is applied.

Referring to FIG. 9, an absolute offset value, depth_dc_abs and offset sign information, depth_dc_sign_flag may be acquired from a bit stream (S900).

The absolute offset value and the offset sign information are syntaxes used to derive the offset value, DcOffset. The offset value DcOffset may be encoded to the absolute offset value and the offset sign information. The offset absolute value and an offset sign information may be obtained as many as the number of the partition in the current depth block.

Specifically, the absolute offset value is the absolute value of the offset value DcOffset, and the offset sign information may indicate the sign of the offset value DcOffset. The offset absolute value and offset sign information may be obtained based on the segment DC flag (sdc_flag). The segment DC flag may indicate whether the offset absolute value and offset sign information are signaled. For example, when the value of the segment DC flag is 1, the offset absolute value and the offset sign information are obtained from the bit stream. If the value of the segment DC flag is 0, the offset absolute value and offset sign information are not obtained from the bit stream, but may be derived as the pre-determined value.

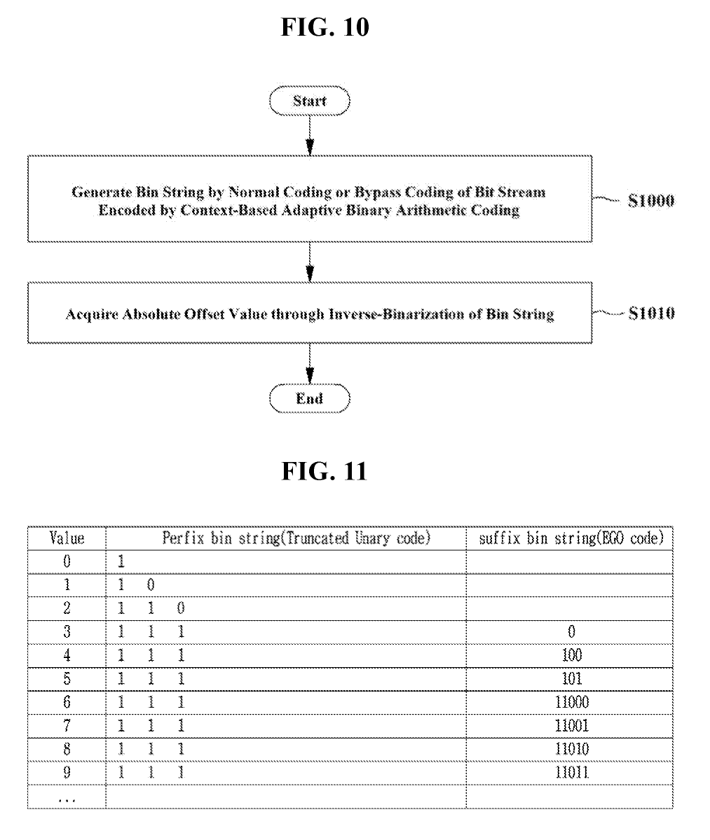

The absolute offset value may be acquired by entropy decoding based on context-based adaptive binary arithmetic coding, which will be described with reference to FIGS. 10 to 13.

Referring to FIG. 9, the offset value DcOffset may be derived using the absolute offset value and the offset sign information acquired in step S900 (S910).

For example, the offset value DcOffset may be derived by [Equation 4].

DcOffset[x0][y0]=(1−2*depth-dc-sign-flag[x0][y0][i])*(depth-dc-abs[x0][y0][i]−dcNumSeg+2 [Equation 4]

In [Equation 4], a parameter dcNumSeg represents the number of partitions in the current depth block and is a constant determined variably according to the number of partitions. However, since the number of partitions in the current depth block may be determined differently according to an intra-prediction mode, the parameter dcNumSeg may be derived in consideration of the intra-prediction mode. Or it may be restricted that the parameter dcNumSeg should have a value (e.g., 1 or 2) within a specific range in order to increase coding efficiency.

Meanwhile, the offset value, DcOffset may be encoded, using a depth look-up table. In this case, the offset value DcOffset may be encoded to an index mapped not to a pixel-domain sample value but to the offset value. The depth look-up table is a table defining a mapping relationship between depth values of video images and indexes allocated to the depth values. If the depth look-up table is used, coding efficiency may be increased by encoding only an index allocated to a depth value, without encoding the depth value on the pixel domain.

Therefore, a prediction depth value may be corrected using a corresponding offset value DcOffset in a different manner depending on whether a depth look-up table is used during encoding the offset value DcOffset.

Referring to FIG. 9, it may be determined whether a depth look-up table is used (S920).

Specifically, it may be determined whether the depth look-up table is used, from a depth look-up table flag dlt_flag. The depth look-up table flag, dlt_flag may indicate whether the depth look-up table is used during encoding or decoding. The depth look-up table flag may be encoded for each layer, view, video sequence, or slice including a corresponding video image.

Referring to FIG. 9, if it is determined that the depth look-up table is used, a corrected prediction depth value may be derived using the offset value DcOffset derived in step S910 and the depth look-up table (S930).

For example, the corrected prediction depth value may be derived by [Equation 5].

predSamples[x][y]=DltIdxToVal[Clip1_{y}(DltValToIdx[predDcVal]+DcOffset)] [Equation 5]

In [Equation 5], predSamples[x][y] represents the corrected prediction depth value, DltIdxToVal[ ] represents a function of converting an index to a pixel-domain depth value using the depth look-up table, DltValToIdx[ ] represents a function of converting a pixel-domain depth value to an index using the depth look-up table, and predDcVal represents a prediction depth value of the current depth block. For example, if the current sample belongs to partition 0, predDcVal is set to a prediction depth value dcValLT of partition 0, and if the current sample belongs to partition 1, predDcVal is set to a prediction depth value dcValBR of partition 1.

First, the prediction depth value predDcVal of the current depth block may be converted to a first index DltValToIdx[predDcVal] corresponding to the prediction depth value, using the depth look-up table. For example, a depth value equal to the prediction depth value predDcVal or a depth value with a minimum difference from the prediction depth value predDcVal may be selected from among the depth values defined in the depth look-up table, and an index allocated to the selected depth value may be determined to be the first index. A second index may be acquired by adding the first index DltValToIdx[predDcVal] to the offset value DcOffset, and converted to a corresponding depth value, using the depth look-up table. Herein, the depth value corresponding to the second index may be used as the corrected prediction depth value.

Referring to FIG. 9, if it is determined that the depth look-up table is not used, a corrected prediction depth value may be derived by adding the offset value DcOffset derived in step S910 to the prediction depth value predDcVal (S940).

The afore-described absolute offset value, depth_dc_abs may be acquired by entropy decoding based on context-based adaptive binary arithmetic coding, which will be described with reference to FIGS. 10 to 13.

FIG. 10 is a flowchart depicting a method for acquiring an absolute offset value by entropy decoding based on context-based adaptive binary arithmetic coding according to an embodiment to which the present invention is applied.

Referring to FIG. 10, a bin string may be generated by normal coding or bypass coding of a bit stream encoded through context-based adaptive binary arithmetic coding (S1000).

Normal coding may be adaptive binary arithmetic coding for predicting the probability of a bin using context modeling, and bypass coding may be coding for outputting a binarized bin string as a bit stream, as it is. Context modeling is modeling of a probability for each bin, and the probability may be updated according to the value of a current encoded bin. In the case of normal coding, a bin string may be generated based on context modeling of an absolute offset value, that is, the occurrence probability of each bit.

An absolute offset value may be acquired by inverse-binarization of the bin string generated in step S1000 (S1010).

Inverse-binarization may mean a reverse operation of binarization of the absolute offset value performed in an encoder. The binarization may be unary binarization, truncated unary binarization, truncated unary/0^{th} order exponential golomb binarization, or the like.

The absolute offset value may be binarized by concatenating a prefix bin string with a suffix bin string. The prefix bin string and the suffix bin string may be expressed in different binarization methods. For example, truncated unary binarization may be used for the prefix bin string, and 0^{th} order exponential golomb binarization may be used for the suffix bin string. Now, a description will be given of binarization of an absolute offset value according to the maximum number cMax of bins in a prefix bin string with reference to FIGS. 11, 12, and 13.

FIGS. 11, 12, and 13 are tables depicting a method for binarizing an absolute offset value according to the maximum number cMax of bins according to an embodiment to which the present invention is applied.

FIG. 11 depicts a binarization method for the case where the maximum number cMax of bins is set to 3. Referring to FIG. 11, an absolute offset value is represented as a concatenation of a prefix bin string and a suffix bin string, and the prefix bin string and the suffix bin string are binarized respectively by truncated unary binarization and 0^{th} order exponential golomb binarization.

If the maximum number cMax of bins is set to 3 and the absolute offset value is 3, the prefix bin string may be represented as 111, and the suffix bin string may be represented as 0. If the absolute offset value is larger than 3, the prefix bin string may be fixed to 111, and the suffix bin string may be represented by binarizing the difference between the absolute offset value and the maximum number of bins according to 0^{th} order exponential golomb binarization.

For example, it is assumed that a bin string 111101 has been generated by context modeling of an absolute offset value. The bin string 111101 may be divided into a prefix bin string and a suffix bin string based on the maximum number cMax of bins. Herein, since the maximum number cMax of bins is set to 3, the prefix bin string may be 111, and the suffix bin string may be 101.

Meanwhile, 3 may be acquired by inverse-binarizing the prefix bin string 111 according to truncated unary binarization, and 2 may be acquired by inverse-binarizing the suffix bin string 101 according to 0^{th} order exponential golomb binarization. The absolute offset value may be 5 by adding the acquired 3 and 2.

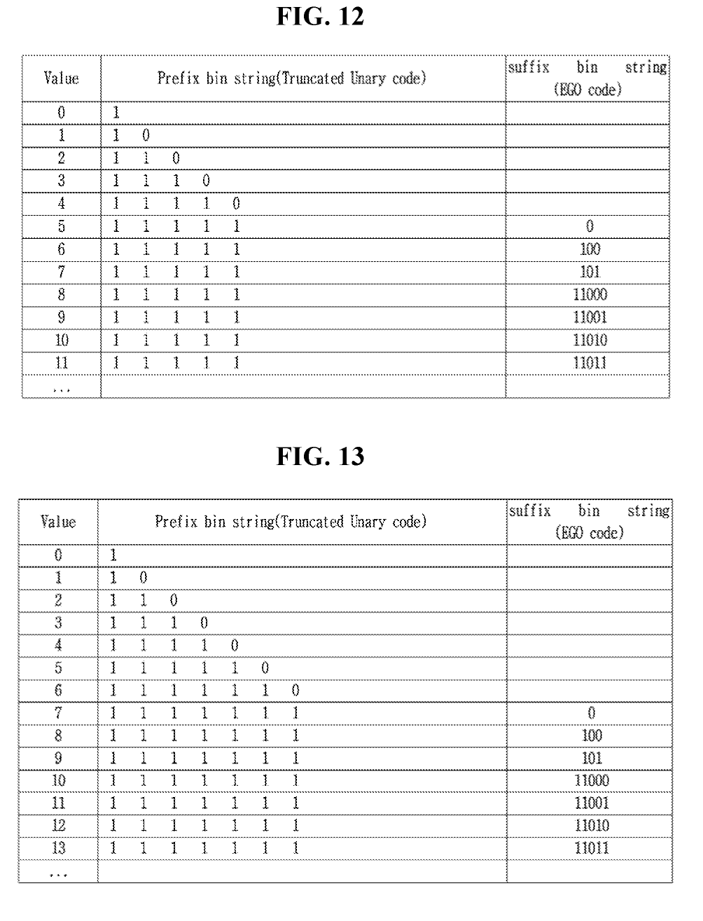

FIG. 12 depicts a binarization method for the case where the maximum number cMax of bins is set to 5. Referring to FIG. 12, an absolute offset value is represented as a concatenation of a prefix bin string and a suffix bin string, and the prefix bin string and the suffix bin string are binarized respectively by truncated unary binarization and 0^{th} order exponential golomb binarization.

If the maximum number cMax of bins is set to 5 and the absolute offset value is 5, the prefix bin string may be represented as 11111, and the suffix bin string may be represented as 0. If the absolute offset value is larger than 5, the prefix bin string may be fixed to 11111, and the suffix bin string may be represented by binarizing the difference between the absolute offset value and the maximum number of bins according to 0^{th} order exponential golomb binarization.

For example, it is assumed that a bin string 11111100 has been generated by context modeling of an absolute offset value. The bin string 11111100 may be divided into a prefix bin string and a suffix bin string based on the maximum number cMax of bins. Herein, since the maximum number cMax of bins is set to 5, the prefix bin string may be 11111, and the suffix bin string may be 100.

Meanwhile, 5 may be acquired by inverse-binarizing the prefix bin string 11111 according to truncated unary binarization, and 1 may be acquired by inverse-binarizing the suffix bin string 100 according to 0^{th} order exponential golomb binarization. The absolute offset value may be 6 by adding the acquired 5 and 1.

FIG. 13 depicts a binarization method for the case where the maximum number cMax of bins is set to 7. Referring to FIG. 13, an absolute offset value is represented as a concatenation of a prefix bin string and a suffix bin string, and the prefix bin string and the suffix bin string are binarized respectively by truncated unary binarization and 0^{th} order exponential golomb binarization.

If the maximum number cMax of bins is set to 7 and the absolute offset value is 7, the prefix bin string may be represented as 1111111, and the suffix bin string may be represented as 0. If the absolute offset value is larger than 7, the prefix bin string may be fixed to 1111111, and the suffix bin string may be represented by binarizing the difference between the absolute offset value and the maximum number of bins according to 0^{th} order exponential golomb binarization.

For example, it is assumed that a bin string 11111111100 has been generated by context modeling of an absolute offset value. The bin string 11111111100 may be divided into a prefix bin string and a suffix bin string based on the maximum number cMax of bins. Herein, since the maximum number cMax of bins is set to 7, the prefix bin string may be 1111111, and the suffix bin string may be 100.

Meanwhile, 7 may be acquired by inverse-binarizing the prefix bin string 1111111 according to truncated unary binarization, and 1 may be acquired by inverse-binarizing the suffix bin string 100 according to 0^{th} order exponential golomb binarization. The absolute offset value may be 8 by adding the acquired 7 and 1.

### INDUSTRIAL APPLICABILITY

The present invention may be used for coding of a video signal.

1. A method for decoding a multiview video signal, the method comprising;
determining an intra-prediction mode of a current depth block;
determining a partition pattern of the current depth block according to the intra-prediction mode; and
deriving a prediction depth value of the current depth block based on the determined partition pattern.

2. The method according to claim 1, wherein determining the intra-prediction mode comprises:
determining, based on at least one of a depth mode DC flag or an intra-view prediction flag, whether the current depth block uses a depth modeling mode, the depth mode DC flag indicating whether at least one of a first depth intra mode or a segment-based DC coding is used in at least one picture belonging to a current sequence, the intra-view prediction flag indicating whether a second depth intra mode is used in at least one picture belonging to the current sequence;
obtaining, based on the depth mode DC flag or the intra-view prediction flag, adaptively DMM identification information relating to the current depth block from the bit stream when the current depth block uses the depth modeling mode; and
determining the intra-prediction mode of the current depth block based on the obtained DMM identification information.

3. The method according to claim 2, wherein the deriving of a prediction depth value comprises deriving a prediction depth value of each partition of the current depth block based on at least one of a position or directivity of a partition line determined according to the partition pattern.

4. The method according to claim 3, further comprising reconstructing the current depth block using the prediction depth value and an offset value (DcOffset) relating to the current depth value,
wherein reconstructing the current depth block comprises:
converting the prediction depth value of the current depth block to a first index, using a depth look-up table;
calculating a second index by adding the first index to the offset value;
calculating a depth value corresponding to the calculated second index, using the depth look-up table; and
reconstructing the current depth block, using the calculated depth value.

5. An apparatus for decoding a multiview video signal, the apparatus comprising;
an intra-predictor for determining an intra-prediction mode of a current depth block, determining a partition pattern of the current depth block according to the intra-prediction mode, and deriving a prediction depth value of the current depth block based on the partition pattern.

6. The apparatus according to claim 5, wherein the intra predictor is configured to:
determine, based on at least one of a depth mode DC flag or a intra-view prediction flag, whether the current depth block uses a depth modeling mode,
obtain, based on the depth mode DC flag or a intra-view prediction flag, adaptively DMM identification information relating to the current depth block from the bit stream when the current depth block uses the depth modeling mode, and
determine the intra-prediction mode of the current depth block based on the obtained DMM identification information,
wherein the depth mode DC flag indicates whether at least one of a first depth intra mode or the segment-based DC coding is used in at least one picture belonging to a current sequence, and the intra-view prediction flag indicates whether a second depth intra mode is used in at least one picture belonging to the current sequence.

7. The apparatus according to claim 6, wherein the intra predictor derives a prediction depth value of each partition of the current depth block based on at least one of a position or directivity of a partition line determined according to the partition pattern.

8. The apparatus according to claim 7, wherein further comprises a reconstructer configured to reconstruct the current depth block using the prediction depth value and an offset value (DcOffset) relating to the current depth block,
wherein the reconstructer is configured to converts the prediction depth value of the current depth block to a first index, using a depth look-up table, calculates a second index by adding the first index to the offset value, calculates a depth value corresponding to the calculated second index using the depth look-up table, and reconstructs the current depth block using the calculated depth value.

9. A method for encoding a multiview video signal, the method comprising;
determining an intra-prediction mode of a current depth block;
determining a partition pattern of the current depth block according to the intra-prediction mode; and
deriving a prediction depth value of the current depth block based on the determined partition pattern.

10. The method according to claim 9, wherein determining the intra-prediction mode comprises:
determining, based on at least one of a depth mode DC flag or an intra-view prediction flag, whether the current depth block uses a depth modeling mode, the depth mode DC flag indicating whether at least one of a first depth intra mode or a segment-based DC coding is used in at least one picture belonging to a current sequence, the intra-view prediction flag indicating whether a second depth intra mode is used in at least one picture belonging to the current sequence;
encoding, based on the depth mode DC flag or the intra-view prediction flag, adaptively DMM identification information relating to the current depth block when the current depth block uses the depth modeling mode; and
determining the intra-prediction mode of the current depth block based on the encoded DMM identification information.

11. The method according to claim 10, wherein the deriving of a prediction depth value comprises deriving a prediction depth value of each partition of the current depth block based on at least one of a position or directivity of a partition line determined according to the partition pattern.

12. The method according to claim 11, wherein further comprising reconstructing the current depth block using the prediction depth value and an offset value (DcOffset) relating to the current depth value,
wherein reconstructing the current depth block comprises:
converting the prediction depth value of the current depth block to a first index, using a depth look-up table;
calculating a second index by adding the first index to the offset value;
calculating a depth value corresponding to the calculated second index, using the depth look-up table; and
reconstructing the current depth block, using the calculated depth value.

13. An apparatus for encoding a multiview video signal, the apparatus comprising;
an intra-predictor for determining an intra-prediction mode of a current depth block, determining a partition pattern of the current depth block according to the intra-prediction mode, and deriving a prediction depth value of the current depth block based on the partition pattern.

14. The apparatus according to claim 13, wherein the intra predictor is configured to:
determine, based on at least one of a depth mode DC flag or a intra-view prediction flag, whether the current depth block uses a depth modeling mode,
encode, based on the depth mode DC flag or a intra-view prediction flag, adaptively DMM identification information relating to the current depth block when the current depth block uses the depth modeling mode, and
determine the intra-prediction mode of the current depth block based on the encoded DMM identification information,
wherein the depth mode DC flag indicates whether at least one of a first depth intra mode or the segment-based DC coding is used in at least one picture belonging to a current sequence, and the intra-view prediction flag indicates whether a second depth intra mode is used in at least one picture belonging to the current sequence.

15. The apparatus according to claim 14, wherein the intra predictor derives a prediction depth value of each partition of the current depth block based on at least one of a position or directivity of a partition line determined according to the partition pattern.
